(19) United States
(12) Patent Application Publication
(10) Pub. No.: US 2020/0032654 A1
(43) Pub. Date: Jan. 30, 2020

(54) Blades Having S-Shaped Profile in the Flow Direction for Radial-Type Impellers

(71) Applicant: TLT-TURBO GMBH, Zweibrücken (DE)

(72) Inventor: Stefan Sebastian STONJEK, Saarbrücken (DE)

(73) Assignee: TLT-Turbo GmbH, Zweibrücken (DE)

(21) Appl. No.: 16/337,684

(22) PCT Filed: Sep. 22, 2017
(86) PCT No.: PCT/EP2017/073997

§ 371 Date: Mar. 28, 2019

(30) Foreign Application Priority Data
Sep. 30, 2016 (DE) 10 2016 218 983.2

(51) Int. Cl. F01D 5/04; F01D 5/14

(52) U.S. Cl. CPC F01D 5/04; F02C 6/12; F01D 5/145

(57) ABSTRACT

The invention relates to an impeller for a turbomachine, in particular a radial turbomachine. The impeller has a number of blades which are held spaced apart from one another on the circumference of the impeller. The blades are designed with a radially running S-shaped contour.

### CROSS REFERENCE TO RELATED APPLICATIONS

This application is the U.S. National Stage entry of International Application Number PCT/EP2017/073997 filed under the Patent Cooperation Treaty having a filing date of Sep. 22, 2017, which claims priority to German Patent Application Number 10 2016 218 983.2 having a filing date of Sep. 30, 2016, which are incorporated herein by reference.

### FIELD OF THE INVENTION

The invention relates to blades having an S-shaped profile in a flow direction for impellers of radial type of construction which are used in turbomachines.

### BACKGROUND OF THE INVENTION

In the context of current development, saving energy and thus reducing the emissions of CO₂ is a declared aim in all sectors. A major part of the overall energy consumption in the EU is caused by turbomachines, predominantly by pumps and fans. Pump and fan manufacturers are encouraged by ever more stringent EU regulations to increase the efficiency of their turbomachines at time intervals (EuP Directive). By increasing the efficiency of turbomachines, the energy that must be provided for driving the machine can be converted into more useful fluid energy. The unusable irreversible part of the energy is reduced.

DE 10 2010 021 220 A1 discloses a rotor and a turbomachine. According to this solution, a rotor comprises a rotor main body and multiple blades arranged along the circumference of the rotor main body. At least one first cable for accommodating centrifugal forces is provided which extends in a circumferential direction in relation to the axis of rotation of the rotor. Radially at the outside, the blades are adjoined by a shroud, wherein the shroud has the at least one first cable for accommodating centrifugal forces acting on the shroud. The shroud in turn has a cavity or a channel in which the at least one first cable is arranged. This solution has the aim of accommodating centrifugal forces that arise during rotation by means of a cable rather than by individual filaments. The use of cables makes it possible to provide a certain degree of elasticity in order to be able to accommodate high levels of momentum, and furthermore, the use of cables constitutes a very inexpensive solution. By virtue of the fact that the at least one cable accommodates at least a part of the acting centrifugal forces, it is made possible for components of the rotor, for example the blades or the rotor body, to be reduced in terms of their material thickness.

CH 698 109 B1 relates to a turbomachine blade. The turbomachine blade comprises a blade airfoil which extends with a blade airfoil longitudinal extent from a blade root to a blade tip. The turbomachine blade has an installation radial direction, an installation circumferential direction and an installation axial direction, and also a threading line. An angle of inclination is defined as the angle exhibited by a projection of the threading line in a plane spanned by the installation circumferential direction and the installation radial direction with the installation radial direction, wherein the angle of inclination varies along the blade airfoil longitudinal extent.

DE 10 2014 104 726 A1 relates to a rotor and a fluid turbine with a rotor. The rotor comprises a vertical rotary axle and at least two rotor blades. These are arranged on the rotary axle, wherein at least one rotor blade comprises at least one opening with an openable closing element.

DE 10 2011 080 804 A1 relates to a two-part impeller for a compressor stage, a turbocompressor and a turbocharger. The impeller is of two-part design and is used in a compressor stage of a turbocompressor, in particular of a radial compressor or of an axial compressor. The impeller is formed from an inflow-side impeller part and an outflow-side impeller part, wherein the outflow-side impeller part has a first number of blades and the inflow-side impeller part has a second, in particular smaller, number of blades. The inflow-side impeller part comprises an internal thread for screwing onto a shaft end of a shaft for the purposes of fastening the impeller to the shaft, wherein outflow edges of the blades of the inflow-side impeller part are situated offset with respect to inflow edges of the blades of the outflow-side impeller part.

In the case of turbomachines of radial type of construction, for example in the case of radial fans, the prior art is to use simple circular-arc-shaped blades or blades with a logarithmic contour. In some cases, use is also made of profiled blades, which however serve primarily for increasing the rigidity of the impeller. Disadvantages of blades provided with an S-bend may for example be higher acting mechanical loads on shroud and support disk in the case of highly loaded impellers, which loads must be structurally counteracted. Furthermore, slightly greater outlay in terms of manufacturing is involved in relation to the circular-arc-shaped blades owing to the inflection point in the blade geometry. The blades are, overall, longer and thus heavier, which necessitates increased use of material. Since such turbomachines generally run uninterrupted for several years the cost saving by means of an energy saving nevertheless greatly exceeds the additional costs for material and the increased outlay in terms of construction.

### SUMMARY OF THE INVENTION

The present invention is based on the object of improving the efficiency of a turbomachine, in particular of a radial turbomachine, in order to convert the energy that must be provided for driving the turbomachine into a greater amount of useful fluid energy. According to the invention, it is proposed that, on an impeller for a turbomachine, in particular for a radial turbomachine with a number of blades which are held spaced apart from one another on the circumference of the impeller, the blades be designed with a radially running S-shaped contour. By means of the solution proposed according to the invention, it is achieved that a widening of the flow channel in the rotor, that is to say in the impeller, is reduced, or is configured to be smoother, and in this way the otherwise common detachment areas of the flow on the suction side of the blade can be reduced in size. This results, in turn, in a reduction of “wake dips” in the outflow from the impeller, whereby mixing losses in the downstream annular diffuser or in the spiral housing are reduced. This in turn makes it possible to increase the efficiency in relation to conventional types of construction, in particular simple circular-arc-shaped blades or logarithmic blades, or alternatively to maintain the efficiency in the case of a greater pressure difference and simultaneously adapt the outlet angle.

In an advantageous embodiment of the solution proposed according to the invention, the S-shaped contour may comprise a first circular arc segment and a second circular arc segment, which transition tangentially into one another at an inflection point. The S-shaped contour, proposed according to the invention, of the blades may also be produced by virtue of firstly a circular arc, then a straight-running piece and then another circular arc being joined together. It is also possible for the S-shaped contour to be realized by joining three circular arcs together. It is important that, through the realization of a substantially S-shaped contour of the blade profile, a channel widening between two adjoining blade airfoils is reduced, and in the ideal case eliminated entirely.

It is advantageously possible for the first and the second circular arc segment to be designed with circular arc radii r₁, r₂ which are identical or different from one another. The joining of two circular arc segments to one another constitutes a very inexpensive design possibility, which is furthermore easy to realize in terms of manufacturing, of the S-shaped contour.

The blades of the impeller extend from an inlet edge to an outlet edge. Their geometry is uniquely defined by the design parameters listed below:
radius r_{E} of the leading edge of the blade,
inlet angle β_{S,E},
radius r₁, r₂ of the first or second circular arc segment,
radius r_{W} of the inflection point,
outlet angle β_{S,A}, and
radius of the outlet edge r_{A}.

The attainable efficiencies of the turbomachine and a flow with little turbulence in the housing of the turbomachine are achieved in the case of inlet angles β_{S,E} at the inlet edge of the blades, which in turn are dependent on the design point, that is to say the optimum operating point of the fan (that is to say of the turbomachine).

The outlet angle β_{S,A} at the outlet edge of the blades is variable in a manner dependent on the desired pressure increase, and may lie between 30° and 120° depending on the design of the turbomachine.

In the case of the impeller proposed according to the invention, the first circular arc segment, extending from the hub, of the S-shaped contour is of over-curved design, whereas the second circular arc segment, adjoining said first circular arc segment at the inflection point, of the S-shaped contour is designed to be curved oppositely to the first circular arc segment and defines the outlet angle β_{S,A}. In the present case, over-curvature means that the curvature is more pronounced than would be required in order to achieve the desired outlet angle if no S-bend were present in the blade airfoil.

The geometry of the blades, that is to say the S-shaped contour, is advantageously designed so as to correspond substantially to the skeleton line of the blades of the airfoil, thickened by the material thickness.

The impeller proposed according to the invention is preferably used in a turbomachine, in particular a radial turbomachine such as a radial fan.

By means of the S-shaped contour proposed according to the invention, it is advantageously possible to achieve that the widening of the flow channel between two mutually adjacent blades on the impeller is reduced, or is configured to be smoother, and therefore the detachment areas of the flow on the suction side of the blade can be reduced in size. This results in a reduced “jet-wake structure” in the outflow of the rotor, whereby the mixing losses in a downstream annular diffuser or in the spiral housing can be significantly reduced. A “jet-wake structure” arises as a result of detachment areas within the rotor. In the relative system of the rotor, in the detachment areas of the flow, the speed is 0, and there is thus no flow through the areas. Thus, the entire flow is forced through the remaining channel cross section, as a result of which the speed prevailing there is considerably higher than if the entire flow were to flow through the entire channel cross section. This change between speed=0 and high-speed enables the “jet-wake structure” to form a short distance downstream of the rotor (jet=stream, wake=dead water).

The reduction of the mixing losses results in turn in a higher efficiency of the impeller proposed according to the invention compared with conventional types of construction in which a simple circular-arc-shaped blade, that is to say a blade geometry without a S-shaped contour, is used, or in the case of a logarithmic blade being used. Secondly, it is also possible, while achieving the same efficiency as in the case of a standard design, to realize a greater pressure difference by virtue of the outlet angle β_{S,A} additionally being increased. A greater efficiency η means either a lower power consumption of the turbomachine while achieving the same pressure difference and the same volume flow, or a greater pressure difference in the case of the same power consumption and the same volume flow. As a final consequence, in this way, the emissions are lowered and the CO₂ emissions are reduced.

### BRIEF DESCRIPTION OF THE DRAWINGS

The invention will be discussed below on the basis of the drawings, in which:

FIG. 1 shows a juxtaposition of a conventional, straight-extending blade profile in relation to the S-shaped contour of the blade proposed according to the invention,

FIG. 2 shows the main design parameters for the definition of the determination of the S-shaped contour of the blade,

FIGS. 3 and 4 show a juxtaposition of detachment areas of the flow on the suction side of impeller blades which have a straight profile and of those designed with the S-shaped contour proposed according to the invention,

FIGS. 5 and 6 show a juxtaposition of the channel widening that occurs in the case of an impeller with a conventional blade geometry and an impeller whose blades are provided with the S-shaped contour proposed according to the invention, and

FIGS. 7 and 8 show a juxtaposition of jet-wake structures (“wake dips”) which occur in the housing of the turbomachine in the case of a conventional design of the blade geometry and in the case of a blade geometry which has the S-shaped contour proposed according to the invention.

### DETAILED DESCRIPTION

In the illustration of FIG. 1, a conventional blade geometry and the S-shaped contour proposed according to the invention for the blades of the impeller are juxtaposed.

A turbomachine, which is only partially illustrated in FIG. 1 and which is a radial turbomachine, for example a radial fan, comprises a housing 12, for example a spiral housing, and is equipped with an impeller 14. The impeller 14, which is only partially illustrated in FIG. 1, comprises blades 16, 18, which between them delimit in each case one intermediate space 20, which constitutes the flow channel for the fluid. As it emerges from FIG. 1, blades 16, 18 of conventional type of construction have a straight contour 24, whereas the blades 16 proposed according to the invention are equipped with a S-shaped contour 26. Reference designation 22 is used to denote detachment areas, situated in each case on the suction side of the blades 16, 18, of the flow. The suction side of the blades 16, 18 is denoted by reference designation 28. The suction side 28 is situated in each case on the rear side of the blades 16, 18 in relation to the direction of rotation of the impeller 14. On the outlet side, that is to say at the end of the blades 16, 18, it is possible to see a “jet-wake structure” indicated by reference designation 30. This “jet-wake structure” arises owing to the detachment areas that occur in the flow in the rotor. In the relative system of the rotor, in the detachment areas, the speed of the flow is 0, such that no flow through said areas occurs. This means that the entire flow is forced through the remaining channel cross section, as a result of which the speed prevailing in the remaining channel cross section is considerably higher (jet) than if the flow were to flow through the full channel cross section. This change between speed=0 and high-speed enables the “jet-wake structure” to form a short distance downstream of the rotor, wherein the expression “jet” means stream and the expression “wake” means “dead water areas”.

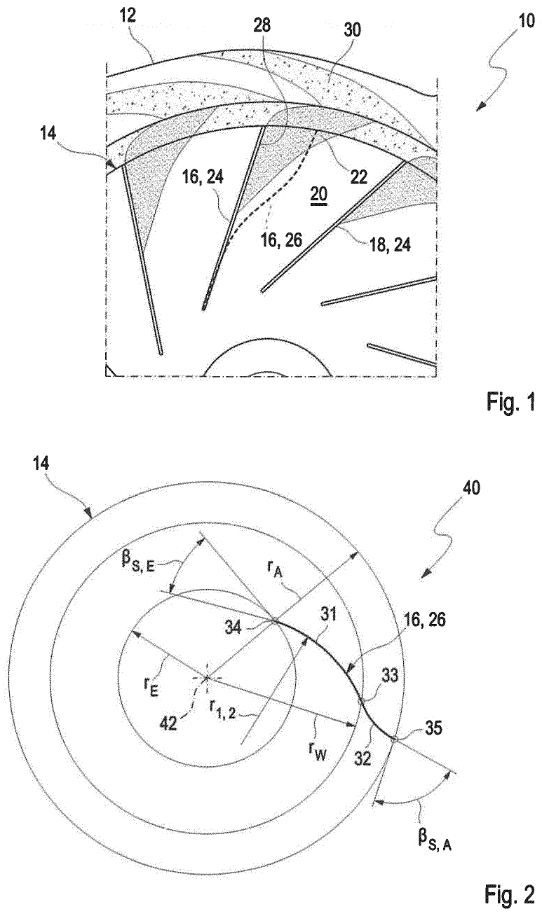

In the illustration of FIG. 2, it is possible to see those design parameters by means of which the S-shaped contour, proposed according to the invention, of the is blades can be uniquely defined.

FIG. 2 shows, in schematically highly simplified form, the impeller 14, the axis of rotation of which is identified by reference designation 42. Proceeding from the axis of rotation 42, there extends a radius r_{E} on which the blade inlet edge of the blade 16 lies. Proceeding from an inlet edge 34, a first circular arc segment 31 of the S-shaped contour 26 extends with a radius r₁. At an inflection point 33, which lies at a corresponding radius r_{W} for the inflection point, the first circular arc segment 31 of the S-shaped contour 26 of the blade 16 transitions into a further, second circular arc segment 32. The second circular arc segment 32, which is situated downstream of the inflection point 33, is curved oppositely in relation to the first circular arc segment, which is of over-curved form. The second circular arc segment 32 extends from the inflection point 33 in a radial direction, that is to say, is leading the flow direction, as far as an outlet edge 35 of the blade. The outlet edge 35 of the blade 16 lies on a radius r_{A}. At the inlet edge 34 of the blade 16, a design-dependent inlet angle β_{S,E} is present. At the outlet edge 35 of the S-shaped contour 26, that is to say at the end of the second circular arc segment 32, an outlet angle β_{S,A} is present. This lies in an angle range between 30° and 120°.

The design parameters 40, r_{E}, β_{S,E}, r₁, r₂, r_{W}, β_{S,A} and r_{A} define the geometry of the S-shaped contour 26 in the case of the latter, in the simplest case, being formed through the use of two circular arcs, that is to say the first circular arc segment 31 and the second circular arc segment 32.

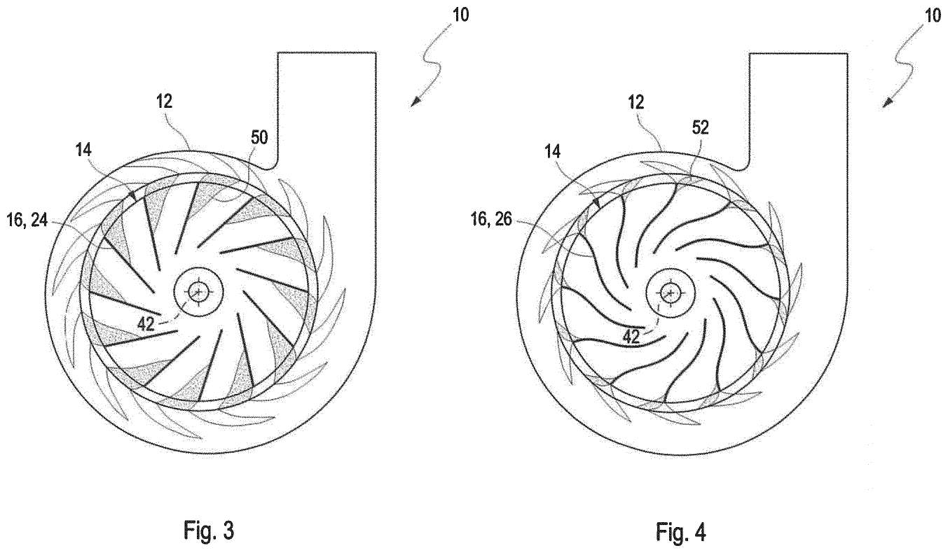

FIGS. 3 and 4 show a juxtaposition of a turbomachine 10 with impeller 14 of conventional design and one which has blades 16 provided with the S-shaped contour 26 proposed according to the invention. In both of the cases illustrated in FIGS. 3 and 4, the main parameters of the impeller, that is to say the inlet angle and the outlet angle, and also the inlet width and the outlet width of the channel cross section, are identical.

It can be seen from the illustration of FIG. 3 that the straight contour 24 of the blades 16, 18 leads to detachment areas 50 on the suction side 28 of the blades 16. The detachment areas 50 that form on the suction side 28 in the design variant as per FIG. 3 give rise to relatively large turbulence losses, which are detrimental to an attainable efficiency.

By contrast, the blades 16 of the impeller 14 as per the illustration in FIG. 4 are designed with the S-shaped contour 26 proposed according to the invention. The detachment areas 52 on the suction side 28 of the blades 16, which are considerably reduced in size in relation to the detachment areas 50 as per FIG. 3, give rise to a considerable reduction of the mixing losses in the housing of the radial turbomachine.

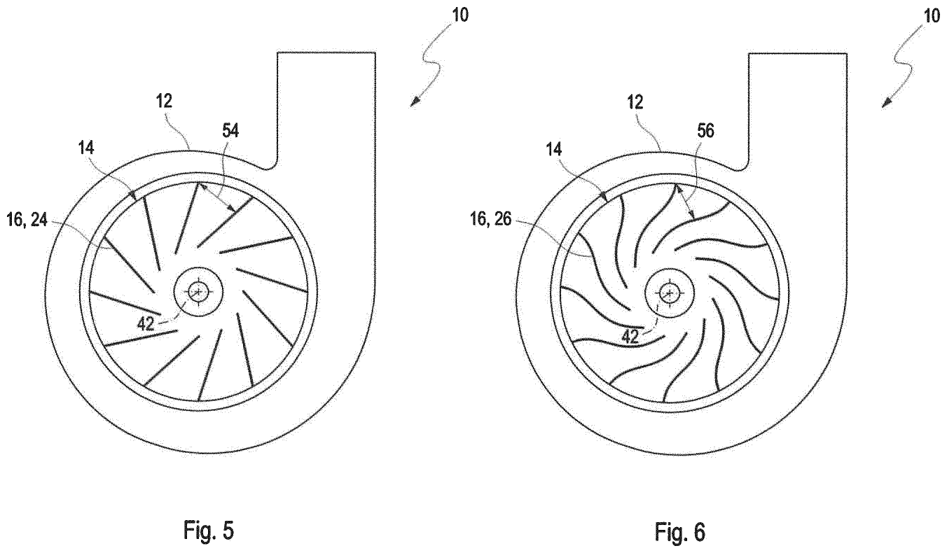

FIGS. 5 and 6 show a juxtaposition of the channel widening between two blades of the impeller for a conventionally designed geometry, that is to say a geometry formed with a straight contour 24, of the blades 16 of the impeller 14, whereas, in FIG. 6, the blades 16 of the impeller 14 illustrated there are designed with the S-shaped contour 26 proposed according to the invention. Whereas, in the case of the illustration as per FIG. 5, a channel widening 54 is formed between two adjacent blades 16 with a straight contour 24, this channel widening is considerably reduced in the case of the design variant of the impeller 14 with blades 16 with an S-shaped contour 26, see the position 56 in FIG. 6. By means of the reduced channel widening 56, the detachment areas 52 of reduced size on the suction side 28 of the blades 16, 18 are achieved, which is beneficial to efficiency and furthermore leads to a reduced “jet-wake structure” (see the explanation given further above) on the outflow side of the impeller 14. This in turn permits a reduction of the mixing losses in the downstream annular diffuser or in the spiral housing of the turbomachine, in particular of the radial turbomachine.

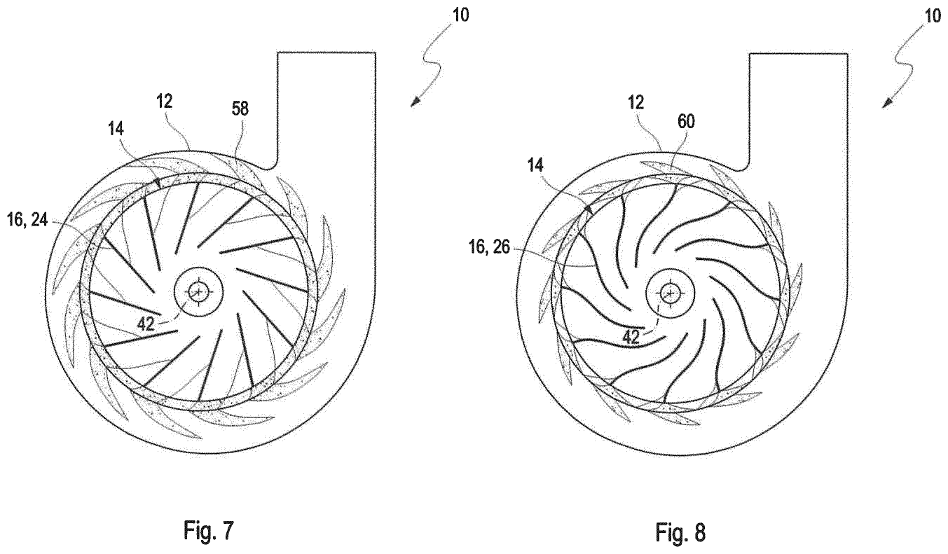

The illustrations of FIGS. 7 and 8 show the “jet-wake structures” which form. Whereas the “jet-wake structure” 58 illustrated in FIG. 7 in the spiral housing of the turbomachine 10 is relatively pronounced, said jet-wake structure is significantly reduced in the design variant as per FIG. 8, in which the blades 16 of the impeller 14 are formed with the S-shaped contour 26 proposed according to the invention, see the reference designation 60. The jet-wake structures 58, 60 are generated substantially by virtue of the fact that different flow speeds prevail in the housing, for example in the spiral housing 12 of the radial turbomachine 10. If parts of the flow which are at a high speed impinge on parts of the flow which are at a low speed, internal friction of the fluid occurs, with the result that the fast flow is decelerated by the slow flow, leading to mixing losses. Mixing losses in turn are highly detrimental to the attainable efficiencies of turbomachines.

In summary, by means of the S-shaped contour 26, proposed according to the invention, of the blades 16, it is possible to specify an impeller 14 for a turbomachine 10 which is distinguished by a reduced channel widening 56, detachment areas 52 of reduced size on the suction side 28 of the blades 16, and by a reduced jet-wake structure 60 in the housing 12 of the turbomachine 10.

The invention is not restricted to the exemplary embodiments described. Rather, further modifications and additions which are evident to a person skilled in the art are possible within the stated scope.

### LIST OF REFERENCE DESIGNATIONS

10 Turbomachine

12 Housing, spiral housing

14 Impeller

16 Blade

18 Further blade

20 Intermediate space, flow channel

22 Turbulence/detachment region of the flow

24 Straight contour

26 S-shaped contour

28 Suction side

30 Jet-wake structure

31 First circular arc segment

32 Second circular arc segment

33 Inflection point

34 Inlet edge of the blade

35 Outlet edge of the blade

40 Construction parameters

r_{E} Radius of blade inlet edge

β_{S,E} Inlet angle

r_{1,2} Circular arc radius

r_{W} Radius of inflection point

β_{S,A} Outlet angle

r_{A} Radius of blade outlet edge

42 Axis of rotation

50 Detachment areas on suction side 28

52 Detachment areas of reduced size on the suction side 28

54 Channel widening

56 Reduced channel widening

58 Pronounced jet-wake structure

60 Reduced jet-wake structure

1. Impeller (14) for a turbomachine (10), in particular a radial turbomachine, having a number of blades (16) which are held spaced apart from one another on the circumference of the impeller (14), characterized in that the blades (16) are designed with a radially running S-shaped contour (26).

2. The impeller (14) as claimed in claim 1, characterized in that the S-shaped contour (26) comprises a first circular arc segment (31) and a second circular arc segment (32), which transition tangentially into one another at an inflection point (33).

3. The impeller (14) as claimed in claim 2, characterized in that the first and second circular arc segments (31, 32) are designed with circular arc radii r₁, r₂ which are identical or different from one another.

4. The impeller (14) as claimed in claim 1, characterized in that the blade (16) is delimited by an inlet edge (34) and an outlet edge (35).

5. The impeller (14) as claimed in any of the preceding claims, characterized in that the S-shaped contour (26) of the blades (16) is defined by the following construction parameters (40):
radius r_{E} of the leading edge (34) of the blade (16),
inlet angle β_{S,E},
radius r₁, r₂ of the first or second circular arc segment (31, 32),
radius r_{W} of an inflection point (33),
outlet angle β_{S,A},
radius of the outlet edge r_{A}.

6. The impeller (14) as claimed in any of the preceding claims, characterized in that the outlet angle β_{S,A} at the outlet edge (35) of the blade (16) lies between 30° and 120°.

7. The impeller (14) as claimed in any of the preceding claims, characterized in that the first circular arc segment (31) of the S-shaped contour (26) is of over-curved design.

8. The impeller (14) as claimed in any of the preceding claims, characterized in that the second circular arc segment (32) is designed to be curved oppositely to the first circular arc segment (31) and defines the outlet angle β_{S,A}.

9. The impeller (14) as claimed in any of the preceding claims, characterized in that the S-shaped contour (26) of the blades (16) corresponds substantially to the skeleton line thereof, thickened by the material thickness.

10. The use of the impeller (14) as claimed in one or more of claims 1 to 9 in a radial turbomachine, in particular in a radial fan.
